(19) United States
(12) Patent Application Publication
(10) Pub. No.: US 2018/0084890 A1
(43) Pub. Date: Mar. 29, 2018

(54) Lip Balm Container with Dental Floss Dispenser

(71) Applicant: Amanda J. Lewis, Decatur, IL (US)

(72) Inventor: Amanda J. Lewis, Decatur, IL (US)

(21) Appl. No.: 15/279,603

(22) Filed: Sep. 29, 2016

(51) Int. Cl. A45D 40/18; A61C 15/04; A45D 40/04

(52) U.S. Cl. CPC A45D 40/18; A45D 40/04; A61C 15/043

(57) ABSTRACT

A lip balm container includes a tubular member having an outer surface and a hollow interior with axial opposite proximate and distal ends. The tubular member has an aperture on its outer surface communicating with the hollow interior. A plunger is disposed in the hollow interior of the tubular member. Lip balm is disposed in a portion of the hollow interior between the plunger and the proximal end. Dental floss is disposed in another portion of the hollow interior between the plunger and the distal end. The dental floss is configured such that a portion of its length is extendable through the aperture.

### BACKGROUND AND SUMMARY

The disclosure relates to a lip balm container with dental floss dispenser.

### BRIEF DESCRIPTION OF THE DRAWINGS

FIG. 1 is a perspective view of a side of a lip balm container as described herein showing dental floss extending from an aperture on the outer surface of the container to a dental floss cutting tool.

FIG. 2 is a perspective view of another side of the lip balm container of FIG. 1, providing additional detail of the dental floss cutting tool.

FIG. 3 is cross-sectional view of the lip balm container from a view similar to that of FIG. 2, showing a plunger, lip balm on one side of the plunger and dental floss on the other side of the plunger.

FIG. 4 is cross-sectional view of an alternate embodiment of a lip balm container showing a plunger, lip balm on one side of the plunger, a wall on the other side of the plunger, and dental floss between the wall and opposite end of the container.

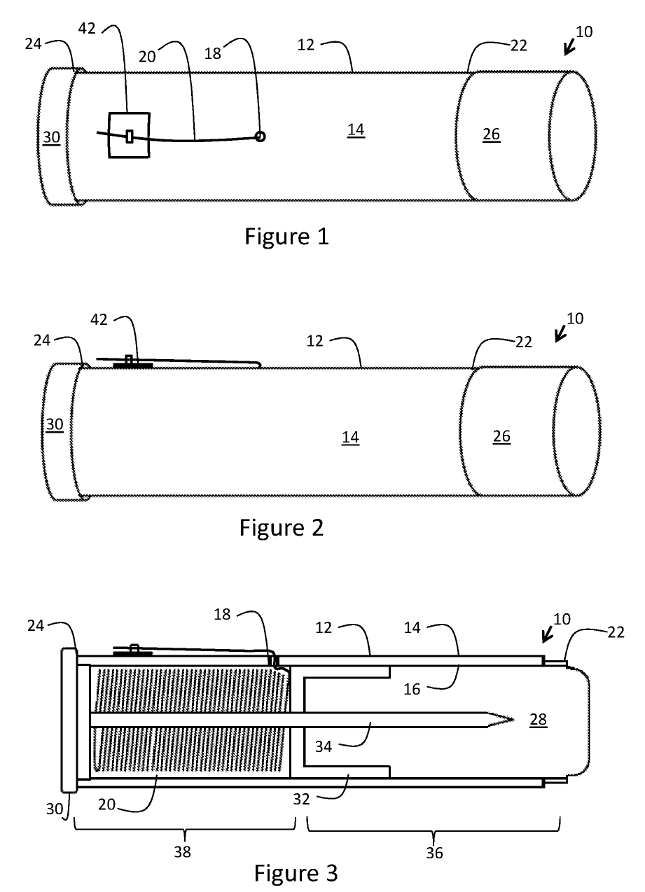

### DETAILED DESCRIPTION

The lip balm container 10 may be formed from a tubular member 12 that has an outer surface 14 and a hollow interior 16. While the drawings show a cylindrical lip balm container, the tubular member is not intended to be limited to a circular cross section and other cross sectional shapes (square, triangle, rectangle, oval) may be used. The tubular member 12 may have an aperture 18 on its outer surface that communicates with the hollow interior 16. As will be explained, dental floss 20 disposed in the hollow interior of tubular member may be directed through the aperture 18 to allow it to be accessed by the user. The tubular member 12 may have axially opposite proximal and distal ends 22,24. The proximal end 22 may be configured to receive a cap 26 that is used to seal the lip balm container. Lip balm 28 may be advanced from the hollow interior 16 of the tubular member out the proximal end 22. The distal end 24 may include an operator 30. As explained below, the operator 30 may be operated to actuate a plunger 32 disposed in the hollow interior of the tubular member to advance the lip balm 28 from the tubular member proximal end. The operator 30 may be a dial operator which may be press fit into the distal end 24 of the tubular member. The operator 30 may be operatively connected to a spindle 34. The spindle 34 may be operatively connected to the plunger 32. Rotation of the operator 30 may in turn cause rotational movement of the spindle 34 and translation of the plunger 32 through the hollow interior of the tubular member so as to advance the lip balm 28 from the proximal end 22 of the tubular member 12. Although rotary motion of the spindle and operator may be used to advance the plunger, the operator may activate a ratcheting system for advancing the plunger, the operator may include a push button for advancing the plunger, or the operator may include an extension of the plunger for advancing the plunger.

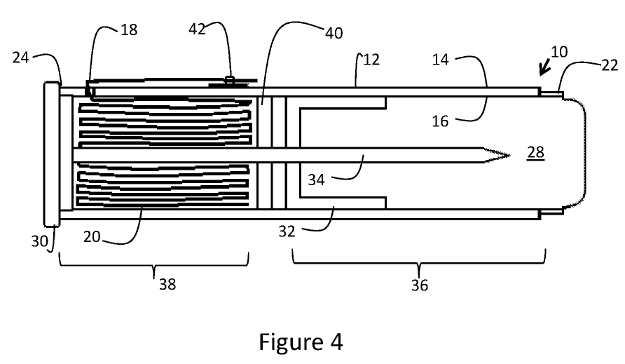

The plunger 32 may in part define a first chamber 36 within the hollow interior 16. The first chamber 36 may contain the lip balm. The plunger 32 may define a second chamber 38 within the hollow interior 16. As will be described in greater detail, the second chamber 38 may contain the dental floss 20. While FIG. 3 shows the plunger in part defining the second chamber for containing the dental floss, the second chamber may be in part defined by one or more walls (see ‘40’ in FIG. 4) in the hollow interior that may be arranged between the plunger 32 and the distal end 24 of the tubular member 16. The dental floss 20 may be disposed in the volume between the wall(s) 40 and the distal end 24 of the tubular member.

The tubular member 12 may include a dental floss cutting tool 42 on its outer surface 14. The dental floss cutting tool 42 may be disposed between the aperture 18 and the distal end 24, and/or the operator 30. The dental floss cutting tool 42 may be spaced from the aperture 18 so as to allow a user to press the dental floss 20 with his or her finger against the outer surface 14 of the tubular member while grasping the free end of the dental floss and manipulating the dental floss against the cutting tool to cut the dental floss. The dental floss cutting tool 42 may be a projection extending from the outer surface 14 of the tubular member 12. The dental floss cutting tool 42 may be formed monolithically with the tubular member 12. The dental floss cutting tool 42 may be a separate member fixed to the outer surface 14 of the tubular member 12. The dental floss cutting tool 42 may be formed from a plastic or may be formed from a metal. The dental floss cutting tool 42 may be configured as is known in the art and used in connection with conventional dental floss containers. The dental floss cutting tool may be covered with a cap (not shown).

As is shown in FIGS. 2 and 3, the aperture 18 is arranged in a midsection of the tubular member 12 and the dental floss cutting tool 42 is disposed between the aperture and the distal end. As shown in the drawings, the aperture 18 is disposed on the tubular member 12 in a location between the dental floss cutting tool 42 and the proximal end 22. However, other arrangements may also be used, for instance as shown in FIG. 4, where the aperture 18 is adjacent to the distal end 24 of the tubular member 12 and the dental floss cutting tool 42 is in the midsection. The dental floss cutting tool 42 may also be provided on the operator.

The dental floss 20 may be disposed in the hollow interior of the tubular member in a location where it may be easily pulled out from the hollow interior of the tubular member. For instance, the dental floss may be arranged in a coil. The coil may have a center axis which is coaxially aligned with a center axis of the tubular member. The coil may extend around the spindle as shown in FIG. 3. The dental floss 20 may also be formed in a bundle which extends in a manner that traverses between the plunger 32 and the distal end 24 of the tubular member, for instance as shown in FIG. 4. The dental floss 20 may be disposed in the hollow interior of the tubular member in a manner so as to not interfere with the spindle 34 or operator 30. A starting end of the length of the dental floss may be arranged adjacent to the aperture 18. To protect the dental floss and maintain it in a hygienic state, the starting end of the dental floss may have a lead which may extend through the aperture 18 to the outside of the container. The lead may be trimmed with the dental floss cutting tool prior to a user using the dental floss. The lead allows the dental floss 20 to be extracted and pulled by the user from the hollow interior 16 and directed through the dental floss cutting tool 42. The dental floss cutting tool 42 may also secure the loose end of the dental floss so as to prevent inadvertent pulling of the dental floss 20 from the hollow interior 16 of the tubular member. The termination end of the length of the dental floss 20 may be placed adjacent to the distal end 242 of the tubular member and may be adjacent to the operator 30.

In preparing the lip balm container 10 for filling, the lip balm container may be provided to a filling entity (e.g., filling the lip balm and/or the dental floss) in the form of a blank or empty tubular member 12 with the plunger 32 positioned in an intermediate position in the hollow interior 16 of the tubular member. The spindle 34, operator 30, and cap 26 may be provided as a kit with the tubular member 12, and either fully or partly assembled with the tubular member and/or plunger. The tubular member 12 may be provided with the dental floss cutting tool 42 on the outer surface 14 of the tubular member. The tubular member 12 may be provided with the aperture 18. To the extent the spindle, operator and/or plunger are assembled with the tubular member, the operator may be manipulated so as to move the plunger to an intermediate position in the hollow interior of the tubular member. The lip balm 28 may be inserted into the hollow interior 16 of the tubular member 12 from the proximal end 22 adjacent to the plunger 32. The dental floss 20 may be inserted into the hollow interior 16 of the tubular member 12 from the distal end 24 by removing the operator 30 from the distal end of the tubular member. The starting end and/or the lead of the floss 20 may be directed from the hollow interior through the aperture. The operator 30 and/or spindle 34 may then be connected with the plunger 32 and reinstalled on the distal end 24 of the tubular member. The starting end and/or lead of the dental floss 20 may be secured to the outer surface 14 of the tubular member 12 with an adhesive and/or protective film. The cap 26 may be provided on the proximal end 22 of the tubular member and secured with an adhesive or protective film. The lip balm container 10 may include marketing information, personalized or corporate information, promotional material and other information on the outer surface 14. The information provided on the outer surface may assist in promoting an entity, the sale of the lip balm container, or other goods and services used in connection with the lip balm or dental floss.

The embodiments were chosen and described in order to best explain the principles of the disclosure and practical applications thereof to thereby enable others skilled in the art to best utilize the various embodiments and with various modifications as are suited to the particular use contemplated. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A lip balm container comprising:
a tubular member having an outer surface and a hollow interior with axial opposite proximal and distal ends, the proximal end being configured to receive a cap, the distal end being configured to receive an operator, the tubular member having an aperture on its outer surface communicating with the hollow interior;
a plunger configured to be disposed in the hollow interior operatively connected to the operator, the plunger being configured to move within the hollow interior and advance lip balm from the proximal end of the tubular member; and
a dental floss cutting tool disposed on the outer surface of the tubular member.

2. The lip balm container of claim 1 wherein the dental floss cutting tool is disposed between the aperture and the dial operator.

3. The lip balm container of claim 1 wherein the tubular member is cylindrical.

4. The lip balm container of claim 1 further comprising dental floss disposed in the hollow interior of the tubular member between the dial operator and the plunger.

5. The lip balm container of claim 1 further comprising lip balm in the hollow interior of the tubular member between the plunger and the tubular member proximal end.

6. The lip balm container of claim 1 wherein the plunger defines a first chamber within the hollow interior for containing lip balm and a second chamber within the hollow interior for containing dental floss.

7. The lip balm container of claim 6 wherein the aperture communicates with the second chamber.

8. A lip balm container comprising:
a tubular member having an outer surface and a hollow interior with axial opposite proximal and distal ends, the distal end having an operator for advancing lip balm from the hollow interior out the proximal end, the tubular member having an aperture on its outer surface communicating with the hollow interior;
a plunger in the hollow interior operatively connected to the operator;
lip balm disposed in a portion of the hollow interior adjacent the plunger in a manner to be advanced from the proximal end of the tubular member by movement of the operator;
dental floss disposed in another portion of the hollow interior adjacent to the operator, the dental floss being configured such that a portion of its length is extendable through the aperture.

9. The lip balm container of claim 8 further comprising a dental floss cutting tool disposed on the outer surface of the tubular member.

10. The lip balm container of claim 9 wherein the dental floss cutting tool is disposed between the aperture and the operator.

11. The lip balm container of claim 9 wherein the aperture is disposed between the dental floss cutting tool and the proximal end.

12. The lip balm container of claim 8 wherein the plunger defines a first chamber within the hollow interior for containing the lip balm and a second chamber within the hollow interior for containing the dental floss.

13. The lip balm container of claim 12 wherein the aperture communicates with the second chamber.

14. The lip balm container of claim 8 wherein the dental floss is arranged in a coil having a center axis coaxially aligned with a center axis of the tubular member.

15. A lip balm container comprising:
a tubular member having an outer surface and a hollow interior with axial opposite proximal and distal ends, the tubular member having an aperture on its outer surface communicating with the hollow interior;
a plunger in the hollow interior;
lip balm disposed in a portion of the hollow interior between the plunger and the proximal end; and
dental floss disposed in another portion of the hollow interior between the plunger and the distal end, the dental floss being configured such that a portion of its length is extendable through the aperture.

16. The lip balm container of claim 15 further comprising a dental floss cutting tool disposed on the outer surface of the tubular member.

17. The lip balm container of claim 16 wherein the dental floss cutting tool is disposed between the aperture and the distal end.

18. The lip balm container of claim 16 wherein the aperture is disposed between the dental floss cutting tool and the proximal end.

19. The lip balm container of claim 15 wherein the plunger defines a first chamber within the hollow interior for containing the lip balm and a second chamber within the hollow interior for containing the dental floss.

20. The lip balm container of claim 19 wherein the aperture communicates with the second chamber.
